(19) United States
(12) Patent Application Publication
(10) Pub. No.: US 2025/0145468 A1
(43) Pub. Date: May 8, 2025

(54) IMPROVEMENTS IN OR RELATING TO GRAPHITE PROCESSING

(71) Applicant: Graphene Star Ltd, Twickenham (GB)

(72) Inventors: Sergey Alekseev, Twickenham (GB); Marina Starkova, Twickenham (GB)

(21) Appl. No.: 18/835,986

(22) PCT Filed: Feb. 6, 2023
(86) PCT No.: PCT/EP2023/052885

§ 371 Date: Aug. 5, 2024

(30) Foreign Application Priority Data
Feb. 7, 2022 (GB) 2201523.4

(51) Int. Cl. C01B 32/215; B01J 19/00; B01J 19/18

(52) U.S. Cl. CPC C01B 32/215; B01J 19/0066; B01J 19/18; C01P 2006/40; C01P 2006/80

(57) ABSTRACT

A method for processing graphite in a flow reactor including (i) providing a flow reactor with (a) a vessel for receiving a reaction mixture comprising natural graphite and water; (b) an activator for imparting rotational motion to the reaction mixture; and (c) at least one input channel for introducing the reaction mixture into the vessel, wherein the activator is rotatably mounted on a hollow tube which provides the input channel; (ii) introducing the reaction mixture into the vessel; (iii) operating the activator to process the reaction mixture; obtaining the processed reaction mixture from the vessel; and optionally repeating steps (ii) to (iv) with the processed reaction mixture one or more times

### CROSS-REFERENCE TO RELATED APPLICATION(S)

This application is a Section 371 National Stage Application of International Application No. PCT/EP2023/052885, filed 6 Feb. 2023, and published as WO 2023/148390 on 10 Aug. 2023, in English, which claimed priority to GB Application No. 2201523.4, filed on 7 Feb. 2022, the contents of which are hereby incorporated by reference in their entirety.

### BACKGROUND

The present invention relates to a hydrodynamic method for processing natural graphite in a flow reactor, to a flow reactor for use in the method, and to a conductive composition which is substantially free from additional impurities from the purification method.

Graphite is an allotrope of carbon having a crystalline structure. Graphite is a mineral substance which is a form of coal. Graphite has a lattice structure comprising graphene sheets, separated at a distance of about 0.335 nm. A scientific definition of graphene refers to a single sheet of graphene obtained from graphite but commercial graphene may comprise more than one sheet or layer. Graphene layers are very strong and conduct heat and electricity efficiently.

Graphene is useful in many applications including electromagnetic shielding and far infrared heating solutions. However, it is expensive to manufacture or to purchase. Alternative sources of conductive material have been sought which have similar properties to graphene.

Mined graphite typically has a purity of about 80 to 85% by weight (calculated as the weight of carbon relative to its total weight). Known methods for purifying graphite either involve flotation process purification with a hydrohalic acid such hydrogen fluoride or hydrogen chloride or baking the graphite. Flotation process-purified graphite obtained by such methods typically has a purity of about 94 wt % but contains a hydrohalic acid residue. Typically, such flotation process-purified graphite has a value of about US$800 per tonne. To obtain graphene with a purity of 95-97 wt %, high conductivity, and containing few layers involves additional, expensive processing of the flotation process-purified graphite. The value of such graphene is typically around US$1200 per tonne.

A way of ameliorating these problems has been sought.

### SUMMARY

According to the invention there is provided a method for processing graphite in a flow reactor which method comprises the steps of:
(i) providing a flow reactor which comprises (a) a vessel for receiving a reaction mixture comprising natural graphite and water; (b) an activator for imparting rotational motion to the reaction mixture; and (c) at least one input channel for introducing the reaction mixture into the vessel, wherein the activator is rotatably mounted on a hollow tube which provides the input channel;
(ii) introducing the reaction mixture into the vessel;
(iii) operating the activator to process the reaction mixture;
(iv) obtaining the processed reaction mixture from the vessel; and optionally repeating steps
(ii) to (iv) with the processed reaction mixture one or more times.

According to the invention there is also provided a flow reactor for use in the invention wherein the flow reactor for purifying graphite comprises (a) a vessel for receiving a reaction mixture comprising natural graphite and water; (b) an activator for imparting rotational motion to the reaction mixture; and (c) at least one input channel for introducing the reaction mixture into the vessel; wherein the activator is rotatably mounted on a hollow tube which provides the at least one input channel.

According to the invention there is further provided a conductive composition which comprises graphite; wherein the composition has a carbon content of at least 96%; wherein the composition has a conductivity of greater than 60,000 S/m; and wherein the graphite is substantially free from an additional impurity.

Advantages of the invention include that it provides a new method of processing and cleaning graphite, which has a very high efficiency and better environmental safety than any other known methods of cleaning graphite. In particular, the method uses water to purify graphite and so does not introduce any impurities into the purified graphite obtained. By use of the method, natural graphite can be cleaned of impurities and further processed to obtain the conductive composition. Furthermore, the method is low energy and does not require crushing the graphite. One of the advantages of avoiding the use of crushing is that there is a substantial reduction of the risk of introduction of metal impurities into the purified graphite product. By using water to purify graphite instead of chemicals such as hydrohalic acids, the need for further purification steps is reduced or avoided which reduces the amount of time taken and the costs of processing. The conductivity of the conductive composition according to the invention is similar to that of graphite having a purity of 97-99.9 wt % but is obtainable at much lower cost than that required to process purified graphite.

Further advantages of the invention include:
a significant increase in the electrical conductivity of natural graphite after processing by the method of the invention. The increase in the electrical conductivity of graphite after processing is believed to be a consequence of a significant reduction in pollutants on the surface and edges of graphite particles. The increased electrical conductivity in a dried conductive composition may be up to 69000 S/m; and
the degree of the conversion of graphite into graphene may be controlled by selection of the processing time.

In some embodiment, the activator may comprise one or more arms or paddles; for example, from two to twelve paddles, e.g. four or six paddles.

In some embodiments, the activator may impart centrifugal motion to the reaction mixture. In some embodiments, step (iii) of the method of the invention may comprises operating the activator to rotate at a minimum rotational rate of about 1000 rpm. In some embodiments, the minimum rotational rate of the activator may be about 2000 rpm. In some embodiments, the maximum rotational rate of the activator may be about 5000 rpm. In some embodiments, the maximum rotational rate of the activator may be about 3500 rpm. In some embodiments, the rotational rate of the activator may be about 3000 rpm.

In some embodiments, step (ii) may comprise introducing the reaction mixture at a minimum flow rate of about 50 litres per minute. In some embodiments, the minimum flow rate may be about 100 litres per minute. In some embodiments, the minimum flow rate may be about 200 litres per minute. In some embodiments, the minimum flow rate may be about 300 litres per minute. In some embodiments, step (ii) may comprise introducing the reaction mixture at a maximum flow rate of about 800 litres per minute. In some embodiments, the maximum flow rate may be about 600 litres per minute. In some embodiments, the maximum flow rate may be about 400 litres per minute.

In some embodiments, step (iii) may be carried out for a period of time in a single cycle, referred to herein as the processing time. In some embodiments, step (ii) may be carried out at the same time as step (iii) and the total processing time may be the total time taken to perform steps (ii) and (iii) in a single cycle. In some embodiments, a minimum processing time may be one minute. In some embodiments, a minimum processing time may be two minutes. In some embodiments, a minimum processing time may be three minutes. In some embodiments, a minimum processing time may be four minutes. In some embodiments, a maximum processing time may be 20 minutes. In some embodiments, a maximum processing time may be 15 minutes. In some embodiments, a maximum processing time may be 10 minutes. In some embodiments, a maximum processing time may be eight minutes.

In some embodiments, the reactor vessel may be a pressurised reactor vessel. In some embodiments, step (iii) of the method of the invention may be performed after step (ii) such that the reactor vessel may be pressurised. In some embodiments, step (iii) of the method of the invention may be performed at the same time as step (ii) where the reactor vessel may be pressurised and where a source of the reaction mixture is a pressurised source of reaction material. In some embodiments, the reactor vessel and/or the pressurised source of reaction material may have a minimum pressure of about 150 kPa. In some embodiments, the minimum pressure may be about 200 kPa. In some embodiments, the minimum pressure may be about 250 kPa. In some embodiments, the minimum pressure may be about 300 kPa. In some embodiments, the reactor vessel and/or the pressurised source of reaction material may have a maximum pressure of about 600 kPa. In some embodiments, the maximum pressure may be about 500 kPa. In some embodiments, the maximum pressure may be about 400 kPa.

In some embodiments, steps (ii) and (iii) of the method of the invention may comprise the use of a graphite processing mode to select one or processing parameters. In some embodiments, a graphite processing mode may depend on a processing parameter such as processing time for a single cycle, rotation speed of the activator, reactor vessel pressure, source of reaction material pressure, graphite content in the reaction mixture, and/or flow rate of the reaction mixture into the reactor vessel. For example, the rotation speed may be 2500 rpm, the flow rate may be 400 litres per minute, reactor pressure may be 300 kPa (3 bar), graphite content in the reaction mixture may be 7 wt %, and the single cycle processing time may be about two minutes.

In some embodiments, the flow reactor may comprise at least two activators in the vessel. In some embodiments, the two activators may be counter-rotating activators which are arranged to rotate in opposite directions. In some embodiments, the two activators may be co-axial. In some embodiments, the or each activator may be rotatably mounted on a hollow tube which provides the input channel. Advantages of counter-rotating the activators include that through the interaction of the activators, acoustic waves arise, the frequency of which depends on the profile of the activators and on the speed of rotation of the activators. In some embodiments, step (iii) may comprise the use of one or more acoustic waves to improve processing efficiency.

In some embodiments, the reactor vessel may be connected to a resonator of acoustic vibrations through which the reaction mixture may pass. Advantages of including a resonator in the flow reactor include that the power of acoustic waves improves the efficiency of the method. In some embodiments, the flow reactor may comprise a resonator to aid the formation of the one or more acoustic waves. In some embodiments, the acoustic waves may result from cavitation. In some embodiments, the resonator may be connected to the vessel of the flow reactor by an adaptor. In some embodiments, the resonator may be a substantially spherical resonator. In some embodiments, the size of the resonator and/or the length and/or diameter of the adaptor may be selected to optimise the acoustic resonance frequency to aid the processing of the reaction mixture. In some embodiments, the resonator may be a Helmholtz resonator. In some embodiments, the rotation speed of the activator may be determined according to the resonant frequency of the resonator. In some embodiments, the resonant frequency of the resonator may be calculated using the equation:

$$fo = V / 2 d$$

where fo represents the fundamental or resonant frequency; V represents the velocity of sound in the reaction mixture; and d represents the dimensions of the resonator (typically its length, width, and/or height).

In some embodiments, the resonant frequency of the acoustic resonator may be from 70 to 300 Hz. Advantages of using acoustic waves include that the purity of the graphite in the reaction mixture may be increased to 99 wt % (in terms of carbon content).

In some embodiments, the vessel of the flow reactor may have a circular cross-sectional shape. In some embodiments, the vessel may have circular-shaped sides having a radius where the vessel's width between the circular-shaped sides is less than the radius such that the vessel has an oblate spheroid shape. In some embodiments, the vessel may have circular-shaped sides and the or each activator may be arranged to rotate in a plane which is substantially parallel to the circular-shaped sides. In some embodiments, the or each activator may have a length which is about 75%-95% of the length of a circular-shaped side.

In some embodiments, the flow reactor may comprise two activators and the input channel may have an inner end which is directed between the two activators. Advantages of inputting the reaction mixture between the at least two activators include that the reaction mixture is subjected to maximum laminar flow of the mixture during processing. In some embodiments, the or each activator may have a rotatable activator support. In some embodiments, where there are two activators each having a rotatable activator support, the rotatable activator supports may be co-axial.

In some embodiments, the reaction mixture may comprise natural graphite and water in a minimum weight ratio of about 1:40. In some embodiments, the reaction mixture may comprise natural graphite and water in a minimum weight ratio of about 1:100. In some embodiments, the reaction mixture may comprise natural graphite and water in a maximum weight ratio of about 1:300. In some embodiments, the reaction mixture may comprise natural graphite and water in a maximum weight ratio of about 1:200. In some embodiments, the reaction mixture may consist of natural graphite and water.

In some embodiments, the natural graphite may be mined graphite. In some embodiments, the natural graphite may be unprocessed graphite, for example uncrushed graphite. In some embodiments, the natural graphite may have a minimum purity (or a carbon content) of about 75% by weight. In some embodiments, the natural graphite may have a minimum purity of about 80% by weight. In some embodiments, the natural graphite may have a minimum purity of about 85% by weight. In some embodiments, the natural graphite may have a maximum purity of about 95% by weight. In some embodiments, the natural graphite may have a maximum purity of about 90% by weight.

In some embodiments, the conductive composition may comprise a mixture of graphite and graphene. In some embodiments, the conductive composition may comprise graphite particles and graphene particles up to 10 layers. In some embodiments, the conductive composition may have a minimum amount of about 0.1 wt % of graphene. In some embodiments, the conductive composition may have a minimum amount of about 0.5 wt % of graphene. In some embodiments, the conductive composition may have a minimum amount of about 1 wt % of graphene. In some embodiments, the conductive composition may have a maximum amount of about 5 wt % of graphene. In some embodiments, the conductive composition may have a maximum amount of about 4 wt % of graphene. In some embodiments, the conductive composition may have a maximum amount of about 3 wt % of graphene. In some embodiments, the conductive composition may have a maximum amount of about 2 wt % of graphene. As a skilled person would know, there are various methods for measuring or estimating the graphene content including counting the number of graphene particles in a sample of the purified graphite using an optical microscope.

In some embodiments, the additional impurity may be an impurity which is introduced into the conductive composition or the natural graphite during processing. In some embodiments, the additional impurity may be a metal impurity or a hydrohalic acid impurity.

In some embodiments, the conductive composition consists of graphite and graphene. In some embodiments, the graphene in the conductive composition may comprise up to 10 layers. In some embodiments, the graphite of the conductive composition according to the invention may have a carbon content of at least 96%. In some embodiments, the conductive composition (or the graphite of the conductive composition according to the invention) may have a minimum carbon content of about 97.5 wt %. In some embodiments, the conductive composition (or the graphite of the conductive composition according to the invention) may have a maximum carbon content of about 99.4 wt %. As a skilled person would know, the carbon content of the conductive composition (or of the graphite of the conductive composition according to the invention) may be measured by a loss on ignition method which exposes the graphite to a high temperature (e.g. 450° C.) to determine the contents of its mineral residue (see Dr. Gregory B. Pasternack: “Watershed Hydrology, Geomorphology, and Ecohydraulics: Loss-On-Ignition Protocol”; pasternack.ucdavis.edu). Alternatively, the carbon content of the graphite may be measured by XRF screening and measurement of the electrical conductivity of the graphite in the form of a powder.

In some embodiments, the composition according to the invention may have a maximum conductivity of 69,000 S/m. As a skilled person would know, the conductivity of the composition according to the invention may be measured using the method described in Celzard et al, “Electrical conductivity of carbonaceous powders”: Carbon 40 (2002) 2801-2815 using the purified graphite powder that is pressed between two copper contacts with a pressure of at least 3 MPa and measuring the value of the electrical resistance between the copper contacts using a micro-ohmmeter.

### BRIEF DESCRIPTION OF THE DRAWINGS

The invention will now be illustrated with reference to the FIGURE of the accompanying drawings which is not intended to limit the scope of the claimed invention:

FIG. 1 shows a schematic cross-sectional view of a flow reactor according to the invention.

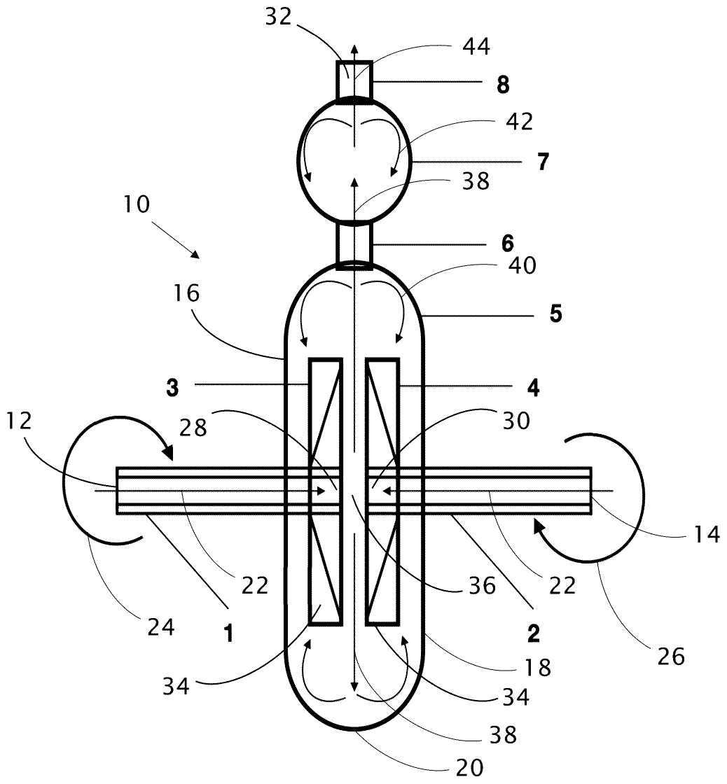

A reactor according to the invention is indicated generally at 10 on FIG. 1. The reactor 10 is for processing natural graphite. Reactor 10 comprises a circular vessel 5, tubes 1,2, activators 3,4 mounted on the tubes 1,2, a spherical resonator 7 connected to the circular vessel 5 by a first adaptor 6, and a second adaptor 8 connected to the spherical resonator 7. The circular vessel 5 has an oblate spheroid (or flattened sphere or disk-like) shape such that it has substantially flat disc-shaped sides 16,18 and a curved circumferential side 20. The volume of the circular vessel 5 is about 1000 litres. The circular vessel 5 is orientated such that its disc-shaped sides 16,18 are substantially vertical.

At the centre of each of the disc-shaped sides 16,18 of circular vessel 5, each tube 1,2 is provided. The tubes 1,2 each have two functions which are to be a rotatable activator support and an input channel. Tubes 1,2 are arranged such that they are co-axial. Tubes 1,2 extend within the circular vessel 5. Each tube 1,2 forms an input channel 12,14 for receiving reactant(s) for insertion into the circular vessel 5, as indicated by input arrow 22. Each tube 1,2 is a rotatable activator support having an activator 3,4 at its inner end 28,30. Each tube 1,2 is rotatable as indicated by rotation arrow 24,26 such that the direction of rotation 26 of tube 2 is opposite to the direction of rotation 24 of tube 1 such that activators 3,4 counter-rotate. Each activator 3,4 which is in the form of a vane which has one or more arms 34 (or paddles 34) which are shaped to impart rotational forces 24,26 on the liquid medium (typically water) within the circular vessel 5. The length of each arm 34 is selected such that the length of the activator is about 80% of the length of the substantially flat disc-shaped sides 16,18.

The spherical resonator 7 is connected to the side 20 of circular vessel 5 by first adaptor 6. The size of the spherical resonator 7 and the length and/or diameter of the first adaptor 6 are selected to optimise the acoustic resonance frequency to aid the processing of the natural graphite. Spherical resonator 7 has a second adaptor 8 which is positioned opposite to the first adaptor 6. Second adaptor 8 has a filter 32 for the separation of the solid graphite/graphene reaction product from the liquid reaction product. Reactant(s) in the space 36 at the centre of circular vessel 5 between the activators 3,4 are subjected to acoustic resonance and to rotational shear forces from the counter-rotating activators 3,4 such that the reactant(s) flow through the circular vessel 5 as indicated by reactant radial flow arrows 38 and by first rotational flow arrows 40 and through the spherical resonator 7 as indicated by the second rotational flow arrows 42. At the end of the reaction, rotation of tubes 1,2 ceases and the contents of the circular vessel 5 and spherical resonator 7 are pumped out 40 through the second adaptor 8 such that filter 32 separates the liquid from the graphite particles.

In an alternative embodiment, the input channels 12,14 may be provided by separate input tubes which may be provided in the curved side 20 of the circular vessel 5 such that the inner end of each input tube is arranged in the central reaction space 36 and the tubes 1,2 may be solid. In an alternative embodiment, the circular vessel 10 may have a single input channel 12.

In use, a reaction mixture of water and natural graphite is introduced into the circular vessel 5 through hollow tubes 1,2. The tubes 1,2 are then counter-rotated as indicated by arrows 24,26. The first adaptor 6 is opened such that the spherical resonator 7 generates acoustic resonance. The reactor 10 is operated to process the reaction mixture for a pre-selected time. The rotation of tubes 1,2 is then stopped and the reaction mixture is pumped out 44 from reactor 10 through filter 32 in the second adaptor 8 to separate water from the graphite/graphene particles.

The processing of the reaction mixture of water and graphite in reactor 10 may have two or more cycles. The number of cycles may be selected depending on the requirements for the resulting graphite product.

The invention is now illustrated by the following Example which is not intended to limit the scope of the inventions claimed.

### EXAMPLE

A mixture of natural graphite with a carbon content of 92% by weight and water in a weight ratio of 1:60 and in a volume of 1000 litres was introduced into circular vessel 5 of reactor 10 at a rate of 250 litres per minute. The frequency of rotation of activators 3,4 was 2900 rpm. The total processing time of the entire volume of the mixture was 10 minutes. The entire volume of the mixture was processed in three cycles through reactor 10.

The conductive composition comprising graphite obtained by the method of this Example had a carbon content of 92% and an increased electrical conductivity compared to dry graphite powder from 46000 S/m to 65000 S/m.

The conductive composition comprising graphite obtained by the method of this Example was examined by optical microscope and its graphene content was estimated to be from 0.1 wt % to 2 wt % by weight of the composition.

1. A method for processing graphite in a flow reactor which method comprises the steps of:
(i) providing a flow reactor which comprises (a) a vessel for receiving a reaction mixture comprising natural graphite and water; (b) an activator for imparting rotational motion to the reaction mixture; and (c) at least one input channel for introducing the reaction mixture into the vessel, wherein the activator is rotatably mounted on a hollow tube which provides the input channel;
(ii) introducing the reaction mixture into the vessel;
(iii) operating the activator to process the reaction mixture;
(iv) obtaining the processed reaction mixture from the vessel; and optionally repeating steps (ii) to (iv) with the processed reaction mixture one or more times.

2. A method as defined in claim 1 wherein the activator comprises one or more arms or paddles.

3. A method as defined in claim 1 wherein the activator imparts centrifugal motion to the reaction mixture.

4. A method as defined in claim 1 wherein the rotational rate of the activator is from 1000 rpm to 5000 rpm.

5. A method as defined in claim 1 wherein the flow reactor comprises at least two activators in the vessel.

6. A method as defined in claim 5 wherein the two activators are co-axial.

7. A method as defined in claim 5 wherein the two activators are counter-rotating activators.

8. A method as defined in claim 1 wherein the flow reactor comprises a resonator to aid the formation of the one or more acoustic waves.

9. A method as defined in claim 8 wherein the resonator is connected to the vessel of the flow reactor by an adaptor.

10. A method as defined in claim 1 wherein the vessel of the flow reactor has a circular cross-sectional shape.

11. A method as defined in claim 1 wherein the vessel has circular-shaped sides and the activator is arranged to rotate in a plane which is substantially parallel to the circular-shaped sides.

12. A method as defined in claim 1 wherein step (iii) comprises the use of one or more acoustic waves to improve processing efficiency.

13. A method as defined in claim 1 wherein the reaction mixture comprises natural graphite and water in a weight ratio of from 1:40 to 1:300

14. A method as defined in claim 1 wherein the reaction mixture consists of natural graphite and water.

15. A method as defined in claim 1 wherein the natural graphite is mined graphite; preferably the natural graphite is unprocessed graphite

16. A flow reactor for use in purifying graphite wherein the flow reactor comprises:
(a) a vessel for receiving a reaction mixture comprising natural graphite and water;
(b) an activator for imparting rotational motion to the reaction mixture; and
(c) at least one input channel for introducing the reaction mixture into the vessel;
wherein the activator is rotatably mounted on a hollow tube which provides the at least one input channel.

17. (canceled)

18. A conductive composition which comprises graphite having a carbon content of at least 97.5%; wherein the composition has a conductivity of greater than 60,000 S/m; and wherein the graphite is substantially free from an additional impurity.

19. A conductive composition as defined in claim 18 wherein the graphite has a carbon content of from 97.5 to 99.4 wt %.

20. A conductive composition as defined in claim 18 which comprises a mixture of graphite and graphene.

21. A conductive composition as defined in claim 18 wherein the additional impurity is an impurity which is introduced into the conductive composition or the natural graphite during processing.
